(19) United States
(12) Patent Application Publication
(10) Pub. No.: US 2010/0153193 A1
(43) Pub. Date: Jun. 17, 2010

(54) VARIABLE-RATE TRANSPORT FEES BASED ON HAZARDOUS TRAVEL CONDITIONS

(75) Inventors: Duncan Ashby, Surrey (GB); Rick A. Hamilton, II, Charlottesville, VA (US); Naveen Lamba, Haymarket, VA (US); James W. Seaman, Falls Church, VA (US); Vinodh K. Swaminathan, Riverside, CT (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Corporation, Armonk, NY (US)

(21) Appl. No.: 12/336,820

(22) Filed: Dec. 17, 2008

(51) Int. Cl. G06Q 50/00; G06Q 10/00; G06Q 30/00; G08G 1/0967; G01W 1/10; G06F 19/00

(52) U.S. Cl. 705/13; 705/400; 340/905; 702/3

(57) ABSTRACT

A system and method are responsive to actual or anticipated weather changes that are likely to have an adverse effect on roadway driving conditions in a given vehicle use area. Based on the anticipated severity of the weather condition, transport-related road and/or parking tolls and fees are increased in order to discourage unnecessary vehicle travel. Using a communication system such as a transponder network, changes in the tolls and fees can be transmitted to toll collection agencies, public parking facilities and other governmental and private enterprises responsible for the collection of vehicle transport fees. Rate change information and details of weather changes can also be transmitted to vehicles likely to be affected by the adverse condition and the consequent change in these fees.

### FIELD OF THE INVENTION

The following generally relates to the field of land and water based transportation, and allocation of fees, tolls and fares based upon present and/or predicted weather patterns having or likely to have an adverse impact on travel conditions.

### BACKGROUND OF THE INVENTION

In the United States, the automobile is by far the most common and generally desired form of daily transportation for commuters of all types. The number of vehicles on the roads continues to grow exponentially, where in some areas, traffic congestion and pollution has become very problematic. Travelers have many differing transportation requirements, options, and habits. Management of transit thoroughfares include public roads, regional and intrastate highways, interstate highways, public toll and access roads, private toll and access roads, and all forms of public/mass transportation. An additional requirement when considering transportation issues is the impact of each existing, planned, and proposed transit system on the environment. One overriding goal is to increase the green nature, that is to say the earth/environment friendliness, of regional transportation systems, thus having the same impact on a national level. In viewing these transit requirements as a whole, many municipalities have difficulty balancing the requirements and desires of commuters against such things as traffic congestion, environmental impact, availability and use of mass transit, and equitable distribution of transit costs.

Water-based travel is also very popular, both for business and for pleasure. Factored into the operation of water crafts are licensing fees, draw-bridge tolls, lock passage fees, docking charges, and fuel costs.

Changing weather conditions and patterns can have a direct impact on the safety of roadways and waterways, particularly with respect to the vehicles and crafts that happen to be using these travel routes at any given period of time.

### SUMMARY OF THE INVENTION

The present invention provides a system and method responsive to actual or potential detrimental driving conditions. Changes are instituted in transport-related road and/or parking fees during the problem period in order to discourage unnecessary vehicle travel.

The invention includes a method and a system for reducing vehicular traffic hazards under adverse weather conditions. Accordingly, weather patterns are monitored and are assessed or analyzed to see if a given weather condition has or might create a potential danger to vehicular traffic within a given geographical area. A determination is then made as to whether an adjustment in a vehicle use fee will or is likely to discourage the operation of vehicles within the area. An adjustment may then be made in the use fee to discourage the operation of vehicles in the area of the adverse weather condition. Preferably, vehicles in the area are alerted or notified concerning the adverse weather condition and the adjustment in use fees.

The invention also relates to a computer system and a computer readable medium using a computer program for monitoring weather patterns and making adjustments in transport fees based on potential or actual weather-related dangers to vehicular traffic. A computer executable program code stored on the readable medium is deployed by the system to enable the program to monitor weather pattern information in a given vehicle use area. The program then assesses if a given weather pattern may present a potential danger to vehicular traffic in said given vehicle use area. If so, the program then determines whether an adjustment of a vehicle use fee will serve to discourage the operation of vehicles in the area of the adverse weather condition. Then, a fee adjustment is implemented.

The invention also relates to producing a computer executable program code and storing the code in a computer readable medium. The code is deployed and executed on a computer system. The program code comprises instructions which, when executed on the computer system, cause the computer system to monitor weather pattern information in a given vehicle use area. Assessing the weather pattern information will determine if the weather may present a potential danger to vehicular traffic in said given vehicle use area. The system then determines whether an adjustment in a vehicle use fee will serve to discourage the operation of vehicles in the area of the adverse weather condition. If so, a fee adjustment is made.

In another aspect, the invention relates to providing a service of regulating vehicle traffic control in a given vehicle use area based on actual or potential adverse weather conditions. The service includes the step of monitoring weather patterns within the vehicle use area. The provider then assesses if a given weather pattern may present a potential danger to vehicular traffic in the area. The provider then determines whether an adjustment in vehicle use fees will serve to discourage the operation of vehicles in the area of the adverse weather condition. If so, the service provider implements an adjustment in fees or instructs fee collection agencies to adjust fees within the area.

### BRIEF DESCRIPTION OF THE DRAWINGS

These and other features of this invention will be more readily understood from the following detailed description of the various aspects of the invention taken in conjunction with the accompanying drawings in which:

FIG. 1 is a block diagram illustrating the logical flow of the system in accordance with the present invention;

FIG. 2 shows a system including a weather center that provides weather hazard information to a plurality of locations; and

FIG. 3. illustrates a computer structure useful in the practice of the present invention.

The drawings are not necessarily to scale but are merely schematic representations, not intended to portray specific parameters of the invention. The drawings serve to depict only typical embodiments of the invention, and therefore should not be considered as limiting the scope of the invention. In the drawings, like numbering is intended to represent like elements.

### DETAILED DESCRIPTION OF THE INVENTION

The present invention addresses the difficult problems relating to vehicular traffic while concomitantly improving highway safety, particularly in and around urban areas. It provides a system and method to automatically increase tolls, tariffs, and other commuter fees (collectively referred to as “transport fees” or “use fees”) in order to discourage individual vehicle travel in anticipation of periods of inclement weather.

The term “vehicle” comprehends automobiles as well as buses, boats, trains, lorries and any apparatus configured to carry drivers and passengers along dedicated thoroughfare infrastructure (e.g. highways, canals, railroad tracks), and which also may define a thoroughfare through their regular paths and schedules (e.g. a shipping channel or inter-coastal waterway).

This invention provides for variable-rate tolls on roads, waterways, and/or parking lots during periods of specific ambient environmental and weather conditions. Such conditions may be those which pose an imminent danger either to the vehicles, to the occupants, to third parties, or to property. The invention dissuades unneeded travel during these time periods by adjusting fees associated with vehicular traffic, and/or lowering fees when such weather conditions are not present.

This invention provides a system and method whereby, upon declaration of a potentially hazardous weather condition, vehicle use fees are increased in order to dissuade unneeded travel in the weather condition area. The process could optionally begin with an alert system tied in with a government authority or other entity such as the national weather forecasting center, which most municipalities already have in place. Such an alert system often takes the form of declaration of a “code red”, “code yellow” or “code green” day, typically relative to air quality, or a program such as “amber alert”. Most often, the announcement of these declarations is transmitted over public airwaves such as on broadcast television, via radio, or increasingly via special local broadcast channels available on cable and satellite networks. This invention builds upon and enhances this system. This invention would modernize broadcast methods and also include state of the art mediums such as in-vehicle systems. These systems include OnStar, GPS, video entertainment systems, pervasive devices, and the like. Some of these systems are able to receive and display such broadcast alerts unaltered, while other systems may need minor updates or modifications.

A category of concern addressed by this invention includes travel conditions that may pose a threat to public safety if vehicles are on the highways. These conditions include, but are not limited to the following:
Ice or snow conditions
Severe weather warning days
High winds, white-outs, sand-storms
Uncontrolled wild fires
Dense fog, heavy rain, and/or flooding

These are conditions that are not made better and will not pass more quickly by eliminating vehicle traffic. However, by reducing traffic during these conditions, a proportional number of accidents, stranded motorists, and other injuries and dangerous situations are avoided, thus increasing citizen safety as a whole. Furthermore, this serves to reduce the need for personnel in emergency functions from being placed in danger while assisting stranded or otherwise endangered citizens.

The weather hazard alert system can utilize a program such as a hazard location algorithm which makes a weather pattern severity determination and coordinates the location of vehicles within the geographical area of the weather hazard. A warning can then be sent to each vehicle within the area likely to be affected by the hazard. This is in addition to a signal that is sent to the various fee collection agencies having collection locations within the geographical area.

In another embodiment of this invention, the change in use fees associated with these adverse conditions would vary by condition, type, and severity of the condition, and whether or not a state of emergency has been declared. Such fees could be assessed in flat monetary amounts, an increased percentage over the standard fee, or a combination of both. Increased fees during these conditions could be applied to toll fees, municipal parking, fuel purchases, and the like. Additionally, where such additional fees are collected by a non municipal agency, a cooperative arrangement could be established. Also contemplated as being within the scope of the present invention is the temporary suspension of tolls and fees during a weather-related mandatory evacuation, in advance of an approaching storm front, surge or the like. This would serve to improve the flow of vehicular traffic, thereby facilitating the exiting of multiple vehicles from an area that is being targeted for the possibility of the potentially devastating weather condition.

Following notification of transit fees is the actual collection of the fee. Existing and/or new electronic collection (EC) systems would be used to collect fees. The EC systems could include, among many other possibilities, a toll collection system, a municipal parking collection system, a service station EC system such as those used with automated gas pumps, or a new EC system established specifically for this purpose using distributed collection readers. Assessed fees might be deferred and paid when other manual collections occur, such as upon payment of taxes, renewal of drivers' licenses or vehicle registrations, payment of regulated utility bills, and the like, or could simply be mailed in the same manner as a parking ticket. Adjudication of disputed fees would also likely follow the method employed for disputing parking tickets.

Finally, the invention would provide for an exemption system whereby municipal and other emergency responders would be exempt from an increased fees (and perhaps from the base fees as well). When conducting business associated with the declared condition, such personnel would utilize transponders programmed to traverse fee based systems free of charge during declared condition periods. Where such fees are collected manually, (a declining occurrence) identification cards would be sufficient.

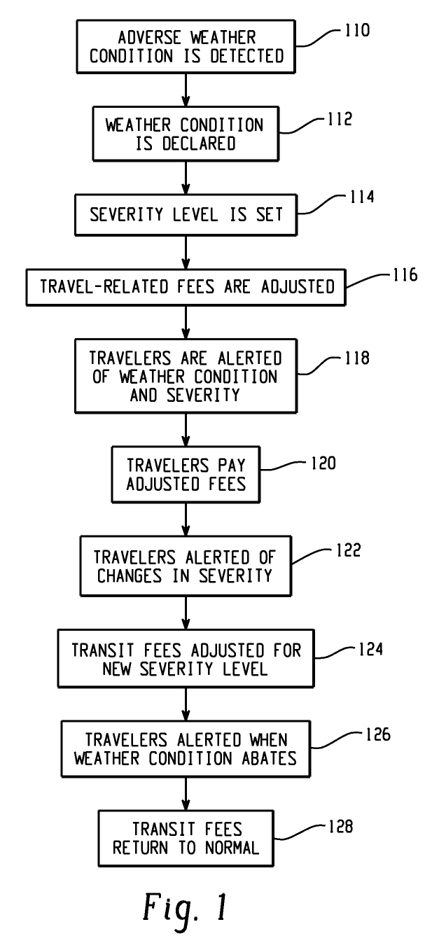

Referring now to the drawings, FIG. 1 represents an example embodiment of the logical flow and process steps of the present invention, as follows.

An adverse weather situation is detected at 110 and is evaluated for extent and severity using a suitable weather pattern monitor. A potential or actual hazardous weather condition is declared (if deemed appropriate) at 112. A severity level is set at 114 for the hazardous weather condition. Using a suitable vehicle use fee adjustment analysis, travel-related fees are adjusted at 116 according to the condition and severity level of the hazardous weather condition. Travelers are alerted of the hazardous weather condition and its severity at 118. Those travelers who are not exempt pay the increased transit fees 120. Commuters are alerted of changes in the severity of the weather at 122. Transport-related fees are adjusted to the changed severity level at 124.

Travelers are alerted at 126 at the declared end of the hazardous condition. Transport-related fees are readjusted back to normal at 128.

It may be noted that certain of these steps may be reordered without loss of applicability for this invention. Also, notification of travelers depends upon their ability to receive traveler alerts in their vehicle or water craft.

Rates randomly and/or deterministically distributed to toll thoroughfare travelers may be published to travelers using a variety of means. For example, as a vehicle travels along or approaches an ingress point to the toll road, notice in real-time of a toll rate change due to a weather condition may be provided to a vehicle occupant through a variety of visual or auditory means. Illustrative but not exhaustive examples include in-dash displays and audio information provided by: an automobile data or GPS system; a broadcast or satellite radio system; a personal data device such as a personal digital assistant (PDA) device, a personal computer or a cellular telephone device; or by communications from a vehicle toll transponder provided along a roadway or waterway. Likewise, an overhead visual system such as that available for Amber Alerts can also be used.

Tolls, tariffs, and fees may be collected/rewarded using manual and automated devices and systems, including fare boxes and automated toll collection systems (EC), for example incorporating EZ-Pass® systems and the like (EZ-PASS is a Trademark of the EZ-Pass Interagency Group in the United States and/or other countries).

Global Positioning Satellite (GPS) systems may also be used to track vehicle road use independent of toll road use and associated automated toll collection (EC) systems, thus extending tolls, fees and credit awards according to the present invention beyond conventional toll thoroughfares. Such automated embodiments offer advantages in enabling simplified implementation, management, and modification of variable rate tolls and fees. In one embodiment, discounts are only available to commuters equipped to use an EC/GPS system, and in another embodiment, a higher toll is paid by those commuters not equipped for EC or GPS. In other examples, a one-time discount, a temporarily reduced toll fee or a long term reduced toll fee is offered to entice commuters to switch to automated EC or GPS systems. EC and GPS systems may also comprehend municipal parking collection systems, vehicle service, fueling or charging stations, for example incorporated into automated fueling pumps or charging stations. Toll fees may also be assessed and collected through other payment and debiting systems and events, for example upon payment of taxes, renewal of a drivers license, payment of regulated utility bills, and the like; or tolls may be invoiced for remittance by the vehicle owner or operator, or even passenger thereof.

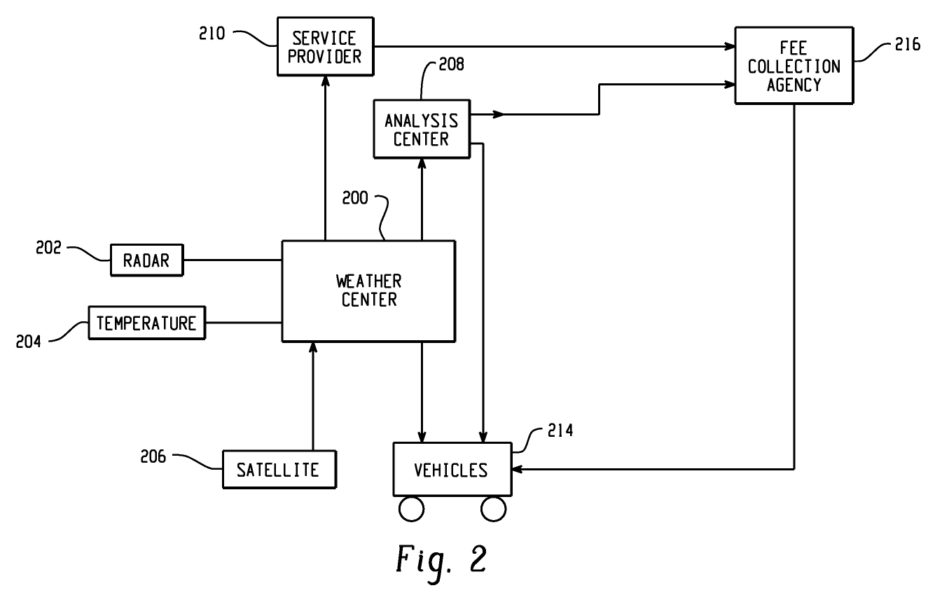

Turning next to FIG. 2, a weather center 200 receives weather-related information from various sources such as radar sites 202, temperature-related sources 204, and weather satellites 206 to name a few. The collected data serves as a source for the predictability of near-term (e.g. 24-48 hours) or longer term shifts in the weather. The predictions may be made by meteorologists or by computers that are programmed to determine the actual or likely development of weather patterns. The predictions may be made at the weather center 200, or the collected information may be transmitted to other locations such as an analysis center 208 under the control of, for example, a governmental agency such as the National Weather Service, for predictive analysis. Alternatively, the information may be submitted to a service provider 210 deployed by the weather service or by an independent source such as a state or federal toll commission responsible for setting toll rates on highways or waterways. Adjustments are then made in the fees and tolls at 212 based on the anticipated severity and duration of the weather crises. The adjustments are then relayed either by the analysis center 208 or the service provider 210 to an agency 216 responsible for fee collection. A corresponding message concerning the weather crisis and the fee adjustments may also be transmitted to those vehicles 214 within the targeted areas that are equipped to receive such information. Provisions may be made to also transmit the weather data from the weather center 200, from the analysis center 208, or from the fee collection agency 216 to vehicles 214 within the zone of a potentially or actual hazardous weather condition, providing the vehicles are equipped to receive such information. It should further be understood that all analysis of weather data and/or the fee adjustment could be performed by the weather center instead of a separate analysis center 208 or service provider 210. The fee adjustment information would then be and transmitted directly to the fee collection agency 216 and/or the vehicles within the target area likely to be affected by the adverse weather condition.

### Computer Implementation

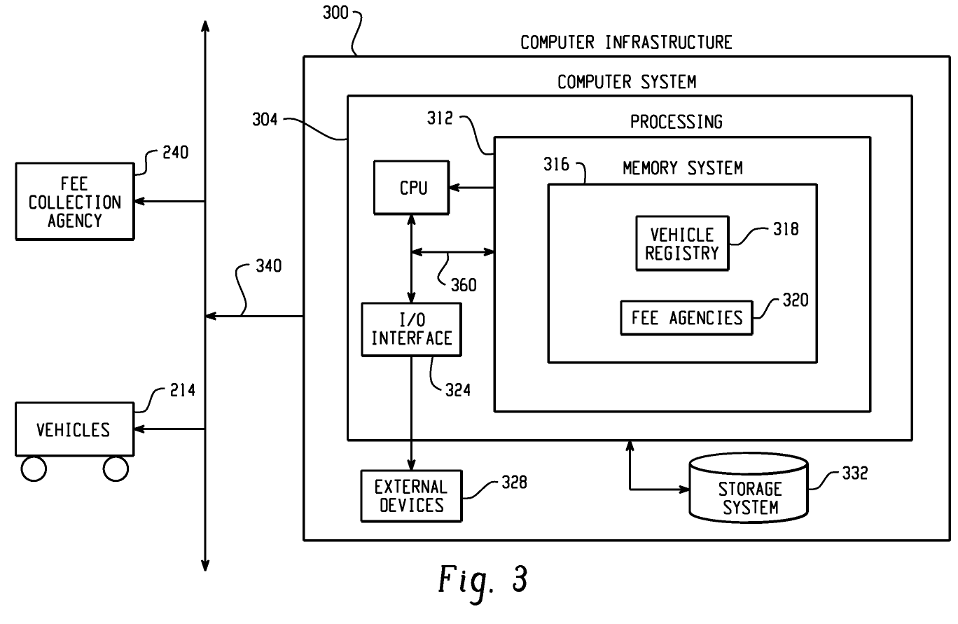

As shown in FIG. 3, a computer infrastructure 300 for implementing the present invention comprises a computer system 304. The computer system 304 typically comprises a central processing unit (CPU) 312, a memory system 316 comprising one or more memory devices, a bus 360, and input/output (I/O) interfaces 324. Within the memory system 316 may be installed a registry 318 containing registration records including VIN numbers of all or selected vehicles currently in operation within a designated geographical area. Typically, the memory 316 may also maintain a listing 320 of vehicle fee-based agencies within a certain geographical area as well as VIN or registration numbers of all land and water vehicles owned or used locally. The fee-based agencies would be contacted in the event of an actual or potentially threatening weather condition as noted at the weather center (200 in FIG. 2). The memory system 316 may also contain fee-based data to enable it to transmit the magnitude of a fee change based on factors, such as the actual or potential severity of an adverse weather condition, to the notification module 126 (FIG. 1), and other components as needed or desired. Further, the computer system 304 is shown in communication with external devices/resources 328 and storage system 332. In general, the central processing unit 312 of the computer system 304 executes computer program code, such as the code to implement notification of vehicles, based on the vehicle registration information stored in registry 318 stored in the memory system 316 and/or database storage system 332.

While executing computer program code, the computer system 304 can read and/or write data to/from the memory system 316, the storage system 332, and/or the I/O interfaces 324. The bus 320 provides a communication link between each of the components in computer system 350. The external devices 328 can comprise any of the previously mentioned components, such as the sensor or detector, the reader, the data steam converter and the user notification module.

Further, I/O interfaces 324 can comprise any system for exchanging information with one or more of the external devices 328. Still further, it is understood that one or more additional components (e.g., system software, math co-processing unit, etc.) not shown in FIG. 3 can be included in computer infrastructure 300. However, if the computer system comprises a handheld device or the like, it is understood that one or more of the external devices 328 (e.g., a display) and/or the storage system 332 could be contained within the computer system 304, not externally as shown. The computer system can further include one or more wired or wireless connections 340 to allow it to communicate with fee collection agencies 240 and with vehicles 214 within the geographical area affected by the adverse weather condition. This capability allows the transfer of updated information for any of the purposes heretofore described.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN), or a storage area network (SAN) (not shown). Also, although not shown, additional components, such as cache memory, communication systems, system software, etc., may be incorporated into computer system 350.

The invention provides a business method that performs the process steps of the invention on a subscription, advertising, and/or fee basis. That is, a service provider could offer to manage the monitoring or reporting of the data. In this case, the service provider can create, maintain, and support, etc., a dedicated or a shared computer system 304. The computer system 304 performs the process steps of the invention for the weather center 200 or for one or more customers, such as toll booth operators, parking lot owners or governmental vehicle or driver registration bureaus. In return, the service provider can receive payment from the customer(s) under a subscription and/or fee agreement.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of an application/software program, component software/a library of functions, an operating system, a basic I/O system/driver for a particular computing and/or I/O device, and the like.

The computer system 304 is only illustrative of various types of computer infrastructures for implementing the invention. For example, in one embodiment, computer system 304 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, computer system 304 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit or CPU 312 may comprise a single processing unit, or be distributed across one or more processing units in one or more locations, e.g., on a client and server. Similarly, the memory and/or the storage system 332 can comprise any combination of various types of data storage and/or transmission media that reside at one or more physical locations.

While shown and described herein as a method and system for detecting adverse operating conditions relating to the operation of a vehicle, it is understood that the invention further provides various alternative embodiments. For example, in one embodiment, the invention provides a computer-readable/useable medium that includes computer program code to enable a computer infrastructure to monitor all systems in the vehicle. To this extent, the computer-readable/useable medium includes program code that implements each of the various process steps of the invention.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined and limited only by the scope and content of the accompanying claims.

What is claimed is:

1. A method for reducing vehicular traffic hazards under an adverse weather condition, comprising:
a) monitoring weather patterns;
b) assessing if a given weather condition may present a potential danger to vehicular traffic in a given vehicle use area; and
c) determining whether an adjustment in a vehicle use fee will serve to discourage the operation of vehicles in the operation area of the adverse weather condition.

2. The method according to claim 1 including making an adjustment in vehicle use fees to reduce the use of vehicles in the vehicle use area.

3. The method according to claim 2 wherein the adjustment in vehicle use fees is made by an agency having an authority to collect vehicle use fees in the operation area.

4. The method according to claim 2 including the step of alerting vehicles in said vehicle use area of the change in weather patterns and vehicle use fees.

5. The method according to claim 1 wherein the adverse weather condition is collected and analyzed by a government agency.

6. A system for reducing vehicular traffic hazards under adverse weather conditions, comprising:
a) a weather pattern monitor;
b) an assessor for determining if a weather pattern may present a potential danger to vehicular traffic in a given vehicle use area; and
c) a vehicle use fee adjustment analysis to determine if a fee adjustment will serve to discourage the operation of vehicles in the operation area.

7. The system according to claim 6 wherein the assessor includes the capability for making a determination that the level of vehicular traffic should be reduced because of the weather condition, and that the imposition of a higher vehicle use fee should serve to reduce vehicular traffic.

8. The system according to claim 8 wherein an adjustment of the vehicle use fee based upon the determination is made by an agency responsible for imposing vehicle use fees in the vehicle use area.

9. The system according to claim 7 further including a vehicle alert having the ability to notify vehicles operating within the weather condition area of the change in weather patterns and the change in vehicle use fees.

10. The system according to claim 1 wherein the adverse weather condition is collected and analyzed by a government agency.

11. In a computer system, a computer program, comprising:
a computer readable medium; and
a computer executable program code stored on the readable medium, the program code deployed by the system to:
a) monitor weather pattern information in a given vehicle use area;
b) assess if a given weather pattern may present a potential danger to vehicular traffic in said given vehicle use area; and
c) determine whether an adjustment in a vehicle use fee will serve to discourage the operation of vehicles in said vehicle use area.

12. In the computer system according to claim 11, the program code further enabling the computer system to determine if the level of vehicular traffic should be reduced because of the weather condition, and if the imposition of a higher vehicle use fee may serve to reduce vehicular traffic.

13. In the computer system according to claim 11, the program code further providing instructions to the computer system to notify fee collection agencies within the vehicle use area to adjust vehicle use fees to discourage the operation of vehicles in the area.

14. In the computer system according to claim 11, the program code further providing instructions to the system to adjust the vehicle use fees.

15. In the computer system according to claim 11, the program code, further enabling the computer to alert vehicles operating within the area of the change in weather and the change in vehicle use fees.

16. A method, comprising:
producing computer executable program code;
storing the code on a computer readable medium; and
providing the program code to be deployed and executed on a computer system; wherein the program code comprises instructions which, when executed on the computer system, cause the computer system to:
a) monitor weather patterns within a vehicle use area;
b) assess if a given weather pattern may present a potential danger to vehicular traffic in the area; and
c) determine whether an adjustment in a vehicle use fee will serve to discourage the operation of vehicles in the area of the adverse weather condition.

17. The method according to claim 16 wherein the program code causes the computer to make a proposed adjustment in a vehicle use fee to discourage the operation of vehicles in the area.

18. The method according to claim 16 wherein the program code causes the computer to transmit the assessed information to at least one agency responsible for imposing a vehicle use fee in the given area.

19. The method according to claim 16, wherein the program code further causes the computer to issue an alert to vehicles operating within the area of adverse weather, advising of the change in weather patterns and the change in vehicle use fees.

20. A method of providing a service of regulating vehicle traffic control in a given vehicle use area based on actual or potential adverse weather conditions, comprising:
a) monitoring weather patterns within said vehicle use area;
b) assessing if a given weather pattern may present a potential danger to vehicular traffic in said area; and
c) determining whether an adjustment in a vehicle use fee will serve to discourage the operation of vehicles in the area of the adverse weather condition.

21. The method according to claim 20 wherein the service also includes transmitting the assessed information to at least one agency responsible for imposing a vehicle use fee in the given area.

22. The method according to claim 20 wherein the service is provided for and on behalf of a highway toll commission.

23. The method according to claim 20 further including instituting an adjustment in a fee or toll for a vehicle use area based on a weather pattern severity determination.
